(19) United States
(12) Patent Application Publication
(10) Pub. No.: US 2011/0100299 A1
(43) Pub. Date: May 5, 2011

(54) Removable and Reconfigurable Perch for Bird Feeder

(75) Inventor: Scott A. Colwell, Dayville, CT (US)

(73) Assignee: Droll Yankees, Inc., Danielson, CT (US)

(21) Appl. No.: 12/938,679

(22) Filed: Nov. 3, 2010

Related U.S. Application Data
(60) Provisional application No. 61/257,985, filed on Nov. 4, 2009.

(51) Int. Cl. A01K 39/00; A01K 39/01

(52) U.S. Cl. 119/52.2; 119/57.8

(57) ABSTRACT

The invention provides a user-configurable perch for a bird feeder. The perch comprises four generally “U”-shaped or “C”-shaped lobes arranged in a generally circular loop, where the loop provides the surface onto which the birds perch. The loop is coupled to a central plate by four support members, which serve to separate the center plate from the loop. The perch is coupled to the bird feeder with a fastener inserted through a hole in the center plate. The perch may be coupled to a bird feeder in one of two configurations. In a first configuration, the loop is positioned below the bottom surface of the bird feeder to accommodate larger birds. In a second configuration, the loop is positioned, above the bottom surface of the bird feeder to discourage larger birds and cater to smaller birds.

### CROSS-REFERENCE TO RELATED APPLICATIONS

This application claims priority to U.S. Provisional Patent Application Ser. No. 61/957,985 entitled “Removable and Reconfigurable Perch for Bird Feeder,” filed on Nov. 4, 2009. The entire contents of the priority application are expressly incorporated by reference herein.

### FIELD OF THE INVENTION

The invention relates generally to the field of bird feeders, and more particularly to a perch that attaches to the bottom of a bird feeder in one of two user-selectable configurations.

### BACKGROUND OF THE INVENTION

A number of bird feeders of different configurations are known and available on the market, many of which comprise a hollow cylindrical container, usually of circular cross section, that has feeding access openings or ports spaced apart both longitudinally and angularly to allow several birds at a time to use the same feeder. Seed trays are often added to the bottoms of these feeders to provide additional space for birds to perch, as well as to catch spilled seed. While the seed trays typically include drainage holes, the trays tend to become dirty because the seed and hulls collect in the trays. In addition, because birds tend to eliminate waste while sitting on the perch, the bird waste may be deposited in the seed tray.

For these reasons, some bird feeders forgo the seed tray and include only a perch, such as a simple elongate rod fixed to the bottom of the feeder. While more complex perches are available, they tend to be designed for a specific type of bird; for example larger birds require larger perches, while smaller perches discourage the larger birds from feeding and cater to smaller birds. In addition, some perches may cause the bird feeder to be unstable if placed on the ground, due to their odd shape or size. Traditional perches also tend to be fixed in place by the manufacturer, which does not allow the user to make adjustments. There is a need in the art, then, for a more versatile perch that can accommodate different types of birds and be configured by the user.

### SUMMARY OF THE INVENTION

The invention provides a user-configurable perch for a bird feeder. The perch can be mounted to the base of a bird feeder by the user in one of two configurations, to either encourage large birds to feed and/or cater to smaller birds, and provides substantially more perching area than conventional feeders.

In preferred embodiments, the bird feeder perch of the invention comprises four generally “U”-shaped or “C”-shaped lobes arranged in a generally circular loop, where the loop provides the surface onto which the birds perch. The loop is coupled to a central plate by four support members, which serve to vertically distance the center plate from the loop. The perch is coupled to the bird feeder through a hole in the center plate, such as with a screw or wing nut.

The bird feeder perch of the invention may be coupled to a bird feeder in one of two configurations. In a first configuration, the loop is positioned below the bottom surface of the bird feeder to accommodate larger birds. In a second configuration, the loop is inverted and positioned above the bottom surface of the bird feeder to cater to smaller birds. Either of the two configurations will encourage birds of different sizes and flocking habits to congregate on the feeder, providing a more pleasant bird-viewing experience for the user.

In a preferred embodiment, a perch for a bird feeder comprises a base section, a plurality of lobes, where the lobes are coupled together to form a continuous loop, and a plurality of support members, where the support members couple the loop to the base section. In an aspect, at least two of the lobes are generally “U”-shaped. In another aspect, at least two of the lobes are generally “C”-shaped. In yet another aspect, the lobes are spaced about the loop such that the loop is generally symmetrical about its x and y axes.

In an aspect, the loop has a larger diameter than the base section. In another aspect, the base section and the loop are offset from, and substantially parallel to, one another. In yet another aspect, the base section is adapted to accept a fastener to couple the perch to the bird feeder. In another aspect, the number of lobes equals the number of support members.

In another preferred embodiment, a perch for a bird feeder comprises a base section lying in a first horizontal plane; a plurality of lobes, where the lobes are coupled together to form a continuous loop, the loop lying in a second horizontal plane substantially parallel to the first horizontal plane; and a plurality of support members, where the support members couple the loop to the base section.

In an aspect, the perch comprises four generally “U”-shaped lobes, where the lobes are spaced about the loop such that the loop is generally symmetrical about its x and y axis. In another aspect, the perch comprises four generally “C”-shaped lobes, where the lobes are spaced about the loop such that the loop is generally symmetrical about its x and y axis. In yet another aspect, the base section defines a hole adapted to accept a fastener to couple the base section to the bird feeder.

In another preferred embodiment, a bird feeder comprises an elongated cylinder having a base; a perch comprising a base section, a plurality of lobes coupled together to form a continuous loop, and a plurality of support members, the support members couple the base section to the loop; the base section lies in a first horizontal plane and the loop lies in a second horizontal plane offset from, and substantially parallel to, the first horizontal plane; and the base section of the perch is coupled to the base of the cylinder.

In an aspect, at least two of the lobes are generally “U”-shaped. In another aspect, at least two of the lobes are generally “C”-shaped. In yet another aspect, the lobes are spaced about the loop such that the loop is generally symmetrical about its x and y axes.

In an aspect, the loop has a larger diameter than the base section. In another aspect, the base section defines a hole adapted to accept a fastener for coupling the base section to the base of the cylinder.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1A is a top view of a bird feeder perch constructed in accordance with the invention;

FIG. 1B is a top view of an alternative embodiment of a bird feeder perch constructed in accordance with the invention;

FIG. 2 is a side view of the bird feeder perch of FIG. 1A;

FIG. 3 is a perspective view of the bird feeder perch of FIG. 1A mounted to a bird feeder in a first configuration; and

FIG. 4 is a perspective view of the bird feeder perch of FIG. 1A mounted to a bird feeder in a second configuration.

### DETAILED DESCRIPTION OF THE INVENTION

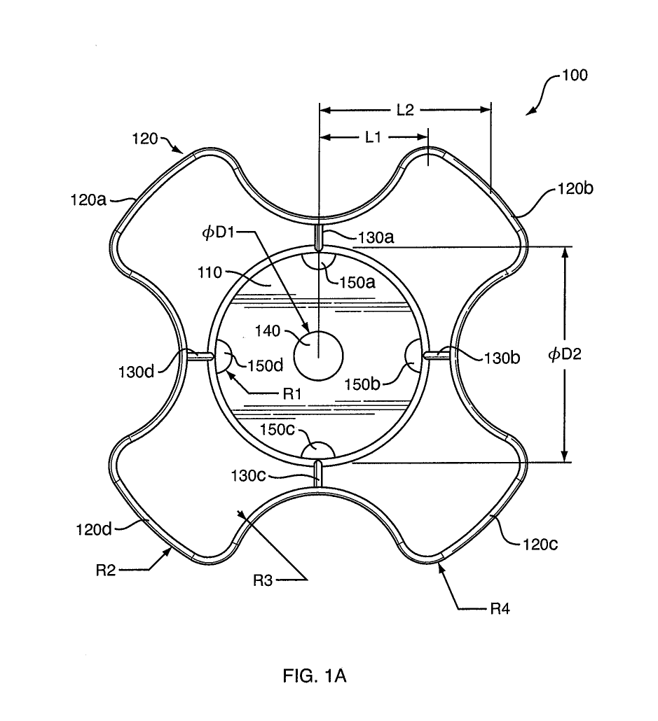

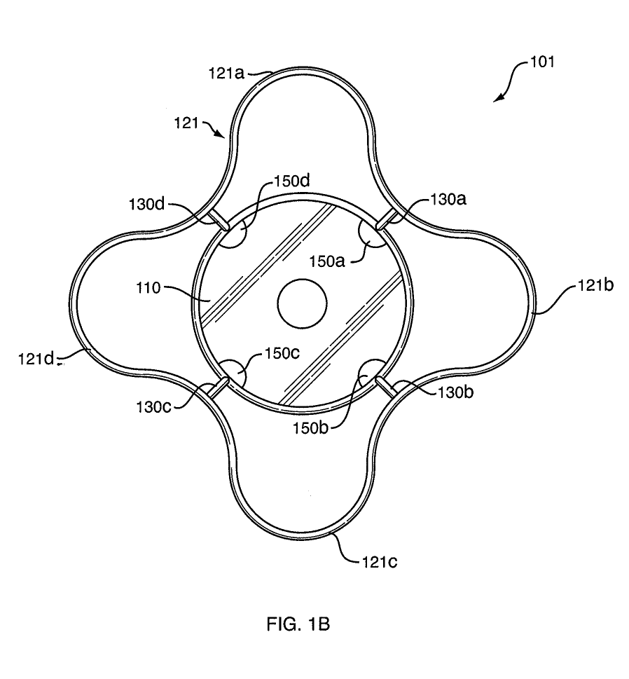

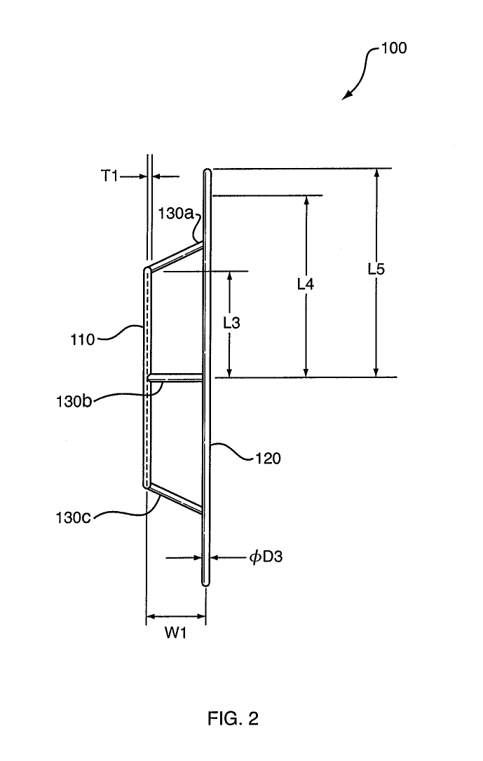

With reference to FIGS. 1A and 2, in a preferred embodiment, bird feeder perch 100 comprises a center plate or base 110, closed loop 120 comprising four protruding lobes, 120A, 120B, 120C and 120D, and four support members, 130A, 130B, 130C, and 130D that couple loop 120 to base 110.

As shown in FIG. 1A, and in a preferred embodiment, the four lobes 120A, 120B, 120C and 120D, are generally “U”-shaped, and are arranged in a generally circular configuration to form a closed loop 120. In an alternate embodiment, and as shown in FIG. 1B, the four lobes 121A, 121B, 121C, and 121D are generally “C”-shaped, and are similarly arranged in a generally circular configuration to form a closed loop 121.

With further reference to FIGS. 1A and 1B, loops 120 and 121, respectively, provide the surface onto which the birds perch. In a preferred embodiment, the four lobes (120A, 120B, 120C and 120D, and 121A, 121B, 121C and 121D, respectively), are spaced such that bird feeder perch (100 and 101, respectively) is symmetrical about both its x and y axes. In alternate embodiments, the bird feeder perch of the invention may be constructed with only two or three lobes, or with as many as six lobes. While not a limitation of the invention, the number of support members may also be adjusted, although a one-to-one correspondence between the number of lobes and the number of support members is preferred for stability.

As shown in FIGS. 1A and 2, loop 120 is coupled to the center plate 110 by the support members, 130A, 130B, 130C, and 130D. As shown in FIG. 2, loop 120 and base 110 lie in horizontal planes that are vertically offset from one another. Accordingly, support members 130A, 130B, 130C, and 130D are angled and extend both vertically and horizontally to accomplish the vertical and horizontal space between the center plate 110 and the loop 120.

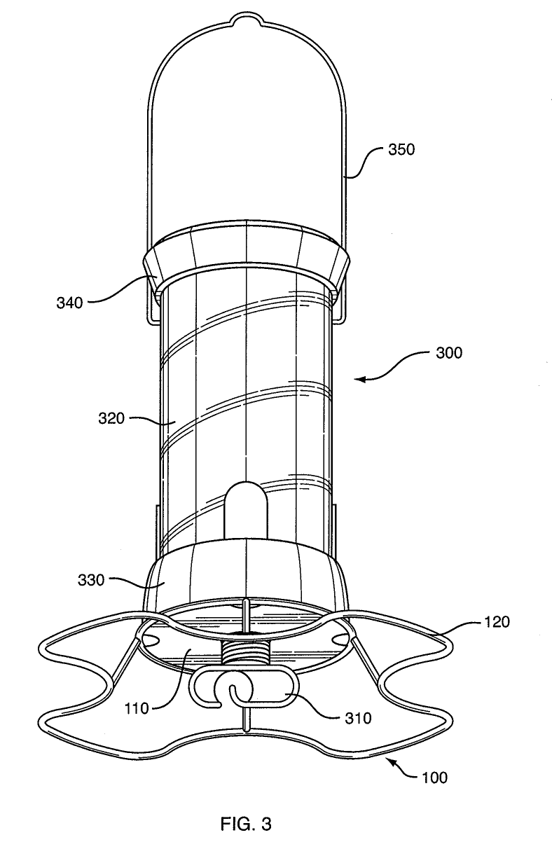

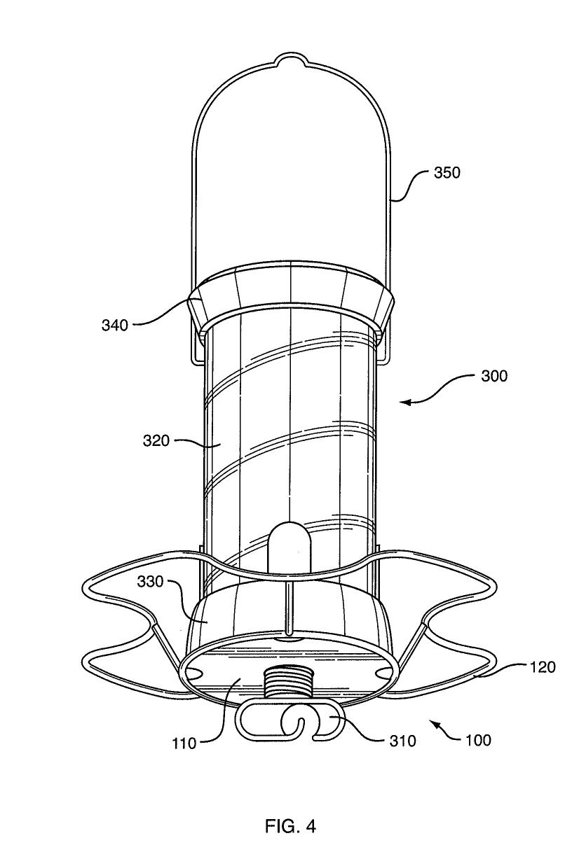

As shown in FIGS. 3 and 4, bird feeder perch 100 is preferably used in conjunction with a bird feeder, such as bird feeder 300. Bird feeder 300 comprises elongated tubular receptacle or cylinder for bird food or seed 320, base 330, removable cover 340, and hanging member 350. Bird feeder perch 100 may be coupled to bird feeder 300 at center plate 110, preferably by inserting a fastener, such as a screw or wing nut 310 through center hole 140 in center plate 110 and into the base 330 of bird feeder 300. Center plate or base 110 is preferably generally circular in shape. In alternate embodiments, center plate or base 110 may be configured to mirror the shape of the base 330 of the bird feeder 300. Center plate or base 110 may further include one or more openings, 150A, 150B, 150C and 150D, for drainage.

Bird feeder perch 100 may be coupled to bird feeder 300 in one of two configurations. FIG. 3 shows bird feeder perch 100 in a first configuration, with the center plate 110 positioned above the loop 120. In this configuration, loop 120 is positioned below the bottom surface of the bird feeder, such that loop 120 accommodates larger birds and encourages them to feed. In addition, in this configuration, bird feeder perch 100 provides a stable surface such that the bird feeder can stand unsupported, thus facilitating refilling the bird feeder.

FIG. 4 shows bird feeder perch 100 in a second configuration, inverted from the first configuration, and with the center plate 110 positioned below the loop 120. In this configuration, loop 120 is positioned above the bottom of the bird feeder, such that loop 120 discourages larger birds, and caters to smaller birds.

In a preferred embodiment, bird feeder perch 100 is constructed of powder coated steel. In alternate embodiments, the steel may be plated or coated with a plastic material, or bird feeder perch 100 may be constructed of stainless steel. Approximate preferred dimensions are included in Table 1, below, and shown in FIGS. 1A and 2. Note that the invention is not limited to these particular dimensions.

| Reference | Approximate preferred | |
|---|---|---|
| Number | dimension (inches) | Description |
| Diameter D1 | 0.083 +/− 0.005 | Diameter of center hole 140 |
| Diameter D2 | 3.63 +/− 0.005 | Diameter of center plate or base 110 |
| Diameter D3 | 0.125 +/− 0.005 | Diameter of wire for loop 120 |
| Length L1 | 1.85 | Distance from center of center hole 140 to outer curve |
| | | or bend of lobe 120A, 120B, 120C or 120D |
| Length L2 | 2.97 | Distance from center of center hole 140 to center of |
| | | lobe 120A, 120B, 120C or 120D |
| Length L3 | 1.849 | Distance from center of center hole 140 to outer edge |
| | | of center plate or base 110 |
| Length L4 | 2.97 | Distance from center of center hole 140 to center of |
| | | lobe 120A, 120B, 120C or 120D |
| Length L5 | 3.823 | Distance from center of center hole 140 to outer edge |
| | | of loop 120 |
| Radius R1 | 0.28 | Radius of opening 150A, 150B, 150C or 150D |
| Radius R2 | 3.94 | Radius of lobe 120A, 120B, 120C or 120D |
| Radius R3 | 1.47 | Radius of curve between two adjacent lobes, 120A and |
| | | 120B, 120B and 120C, 120C and 120D, or 120D and |
| | | 120A |
| Radius R4 | 0.50 | Radius of outer curve of lobe 120A, 120B, 120C or |
| | | 120D |
| Thickness T1 | 0.063 | Thickness of center plate or base 110 |
| Width W1 | 1.00 | Distance between the horizontal plane of center plate |
| | | or base 110 and the horizontal plane of loop 120 |

The claims should not be read as limited to the described order or elements unless stated to that effect. Therefore, all embodiments that come within the scope and spirit of the following claims and equivalents thereto are claimed as the invention.

What is claimed:

1. A perch for a bird feeder, comprising:
a base section;
a plurality of lobes, where the lobes are coupled together to form a continuous loop; and
a plurality of support members, where the support members couple the loop to the base section.

2. The perch of claim 1, where at least two of the lobes are generally “U”-shaped.

3. The perch of claim 1, where at least two of the lobes are generally “C”-shaped.

4. The perch of claim 1, where the lobes are spaced about the loop such that the loop is generally symmetrical about its x and y axes.

5. The perch of claim 1, where the loop has a larger diameter than the base section.

6. The perch of claim 4, where the base section and the loop are offset from, and substantially parallel to, one another.

7. The perch of claim 1, where the base section is adapted to accept a fastener to couple the perch to the bird feeder.

8. The perch of claim 1, where the number of lobes equals the number of support members.

9. A perch for a bird feeder, comprising:
a base section lying in a first horizontal plane;
a plurality of lobes, where the lobes are coupled together to form a continuous loop, the loop lying in a second horizontal plane substantially parallel to the first horizontal plane; and
a plurality of support members, where the support members couple the loop to the base section.

10. The perch of claim 9, comprising four generally “U”-shaped lobes, where the lobes are spaced about the loop such that the loop is generally symmetrical about its x and y axis.

11. The perch of claim 9, comprising four generally “C”-shaped lobes, where the lobes are spaced about the loop such that the loop is generally symmetrical about its x and y axis.

12. The perch of claim 9, where the base section defines a hole adapted to accept a fastener to couple the base section to the bird feeder.

13. A bird feeder, comprising:
an elongated cylinder having a base;
a perch comprising a base section, a plurality of lobes coupled together to form a continuous loop, and a plurality of support members, where the support members couple the base section to the loop;
where the base section lies in a first horizontal plane and the loop lies in a second horizontal plane offset from, and substantially parallel to, the first horizontal plane;
where the base section of the perch is coupled to the base of the cylinder.

14. The bird feeder of claim 13, where at least two of the lobes are generally “U”-shaped.

15. The bird feeder of claim 13, where at least two of the lobes are generally “C”-shaped.

16. The bird feeder of claim 13, where the lobes are spaced about the loop such that the loop is generally symmetrical about its x and y axes.

17. The bird feeder of claim 13, where the loop has a larger diameter than the base section.

18. The bird feeder of claim 13, where the base section defines a hole adapted to accept a fastener for coupling the base section to the base of the cylinder.
